(19) United States
(12) Patent Application Publication
(10) Pub. No.: US 2012/0106702 A1
(43) Pub. Date: May 3, 2012

(54) APPARATUS AND METHOD FOR MULTI-MODAL IMAGING USING MULTIPLE X-RAY SOURCES

(76) Inventor: Gilbert D. Feke, Durham, CT (US)

(21) Appl. No.: 13/305,919

(22) Filed: Nov. 29, 2011

Related U.S. Application Data
(63) Continuation-in-part of application No. 13/238,290, filed on Sep. 21, 2011.
Application No. 13/238,290 is a continuation of application No. 12/763,231, filed on Apr. 20, 2010, now abandoned.
Application No. 12/763,231 is a continuation-in-part of application No. 11/221,530, filed on Sep. 8, 2005, now Pat. No. 7,734,325.
(60) Provisional application No. 61/418,027, filed on Nov. 30, 2010.

(51) Int. Cl. G01N 23/04

(52) U.S. Cl. 378/63

(57) ABSTRACT

An imaging system for imaging at least a first and a second subject has a support stage to support the subjects. An imaging system has an ionizing radiation imaging section with at least a first ionizing radiation source for directing ionizing radiation within a first zone that includes the first subject and a second ionizing radiation source for directing ionizing radiation within a second zone that lies substantially outside the first zone and that includes the second subject. At least one imaging receiver forms an image of the subject within each zone. A camera system obtains at least one image of the at least first and second subjects. A computer is in signal communication with the imaging system and energizable to form a combined image from two or more images of the same subjects.

### CROSS REFERENCE TO RELATED APPLICATIONS

This application claims priority to Provisional application U.S. Ser. No. 61/418,027 filed Nov. 30, 2010 entitled “APPARATUS AND METHOD FOR MULTI-MODAL IMAGING USING MULTIPLE X-RAY SOURCES” by Feke, incorporated herein by reference in its entirety.

This application is a Continuation-in-Part of U.S. Ser. No. 13/238,290 filed Sep. 21, 2011, entitled “APPARATUS AND METHOD FOR MULTI-MODAL IMAGING” by Feke et al., which was itself a Continuation of U.S. Ser. No. 12/763,231 filed Apr. 20, 2010, entitled “APPARATUS AND METHOD FOR MULTI-MODAL IMAGING”, published as US 2010/0220836 (now abandoned), which was itself a Continuation-in-Part of U.S. Ser. No. 11/221,530 filed Sep. 8, 2005 by Vizard et al, entitled “APPARATUS AND METHOD FOR MULTI-MODAL IMAGING”, which granted as U.S. Pat. No. 7,734,325 on Jun. 8, 2010, all of which are incorporated herein by reference in their entirety.

### FIELD OF THE INVENTION

The invention relates generally to the field of imaging systems, and more particularly to the imaging of subjects. More specifically, the invention relates to an apparatus and method that enable analytical imaging of multiple subjects (for example, small animals and tissue) in differing modes, including bright-field, dark-field (e.g., luminescence and fluorescence), and x-ray and radioactive isotope imaging.

### BACKGROUND OF THE INVENTION

Multi-modal electronic imaging systems are known for enabling imaging of animals, for example laboratory mice and rats. An exemplary multi-modal electronic imaging system 10 is shown in FIGS. 1A, 1B, 1C, and 1D. An example of this system is the KODAK In-Vivo Imaging System FX Pro.

System 10 includes an illumination source 12; a sample environment 14 which allows access to the subject or subjects being imaged; an optically transparent platen 16 disposed within sample environment 14; an epi-illumination delivery system comprised of fiber optics 18 which are coupled to light source 12 and direct conditioned light (of appropriate wavelength and divergence) toward platen 16 to provide bright-field or fluorescence imaging; an optical compartment 20 which includes a minor 22 and a lens and camera system 24; a communication and computer control system 26 which can include a display device, for example, a computer monitor; a microfocus x-ray source 28; a sample object support stage 104 on which subjects may be immobilized and stabilized by gravity; and a phosphor plate 125, adapted to transduce ionizing radiation to visible light by means of a phosphor layer, movable along direction indicated by arrow 36. In the illustrated imaging system, lens and camera system 24 are located below sample object support stage 104. Those skilled in the art understand that the system could be reconfigured to provide for imaging from above the support member or from any suitable angle.

Light source 12 can include an excitation filter selector for fluorescence excitation or bright-field color imaging. Sample environment 14 is preferably light-tight and fitted with light-locked gas ports for environmental control. Such environmental control might be desirable for controlled x-ray imaging or for life-support of particular biological specimens. Imaging system 10 can include an access means or member 38 to provide convenient, safe and light-tight access to sample environment 14. Access means are well known to those skilled in the art and can include a door, opening, labyrinth, and the like. Additionally, sample environment 14 is preferably adapted to provide atmospheric control for sample maintenance or soft x-ray transmission (e.g., temperature/humidity/alternative gases and the like). Camera and lens system 24 can include an emission filter wheel for fluorescence imaging. Examples of electronic imaging systems capable of multimodal imaging are known in the art and include those described in U.S. Pat. No. 7,734,325, US 2009/0086908, US 2009/0159805, and US 2009/0238434, for example.

In operation, the system is configured for a desired imaging mode chosen among the available modes including x-ray mode, radioactive isotope mode, and optical imaging modes such as bright-field mode, fluorescence mode, luminescence mode, and an image of a plurality of immobilized subjects 40, such as mice, under anesthesia and recumbent upon frame 120 included in sample object stage 104, is captured using lens and camera system 24. System 24 converts the light image into an electronic image, which can be digitized. The digitized image can be displayed on the display device, stored in memory, transmitted to a remote location, processed to enhance the image, and/or used to print a permanent copy of the image. The system may be successively configured for capture of multiple images, each image chosen among the available modes, whereby a synthesized image, such as a composite overlay, is generated by the combination of the multiple captured images.

Subjects/mice 40 may successively undergo craniocaudal rotation and immobilization directly onto sample object stage 104 in various recumbent body postures, such as prone, supine, laterally recumbent, and obliquely recumbent, whereby the mouse is stabilized by gravity for each body posture, to obtain multiple views, for example ventral and lateral views as described in “Picture Perfect: Imaging Gives Biomarkers New Look”, P. Mitchell, Pharma DD, Vol. 1, No. 3, pp. 1-5 (2006). As shown in FIG. 1D, there are support positions for a plurality of subjects/animals 40 to be imaged at the same time, only one subject being shown for ease of illustration. Animals may be rotated manually about their craniocaudal axes to provide different viewing angles, as indicated by arrow 42.

Multi-modal electronic imaging systems for imaging animals can be comprised of a single microfocus x-ray source which provides a single x-ray cone beam. The distance of the microfocus x-ray source from the phosphor plate and the cone beam divergence angle are typically designed so that the cone beam covers a desired field of view. However, differential geometric magnification between the center and the edge of the cone beam due to the finite thickness of animals causes problematic distortion of the x-ray image, and hence co-registration error between images captured using x-ray mode and images captured using bright-field, fluorescence, or luminescence modes. Co-registration error is defined herein as the quotient of “bn” divided by “a”, where “bn” is the distance between the x-ray representation of feature n of a subject imaged in the first imaging mode and the representation of feature n of an subject in the second imaging mode (different from the first imaging mode), and “a” is the distance (in the same image) between the center of the image and any corner of the image (i.e., the semi-diagonal dimension of the image). Because known multi-modal electronic imaging systems for imaging mice or other small animals accommodate fields of view sufficiently large for two or more animals, the co-registration error in these systems is greater for features of the animals further away from the center of the cone beam. Hence, the ability to anatomically localize molecular signals using x-ray images is degraded for features of the animals further from the center of the cone beam relative to features of the animals nearer to the center of the cone beam in known multi-modal electronic imaging systems for imaging small animals.

FIGS. 2A and 2B illustrate factors of imaging geometry that relate to co-registration error when using imaging system 10, which is exemplary of the co-registration error of known multi-modal electronic imaging systems for imaging animals in general. The semi-diagonal dimension a of frame 120 can be, for example, about 141 mm (corresponding to the 200 mm edge of the square frame of the KODAK In-Vivo Imaging System FX Pro). The distance between x-ray source 28 and the frame 120 can be, for example, about 500 mm. The cone beam from x-ray source 28 covers the plurality of subjects in the embodiment shown. Object 1 is positioned in the center of the cone beam. Object 2 is displaced 50 mm from the center of the cone beam. Features 1 and 2 are part of subjects 1 and 2, respectively, and have centers that are elevated 26 mm above frame 120. This non-zero elevation of features 1 and 2 results in their geometric magnification in the x-ray image. In addition, the differential displacement of features 1 and 2 from the center of the cone beam results in differential geometric magnification in the x-ray image, and hence different co-registration error for features 1 and 2. The difference “b1” between the location of feature 1 in the first (x-ray) image and the location of feature 1 in the second image is 0.6 mm, so that the co-registration error of feature 1 is b1/a=0.6 mm/141 mm=0.004. The difference “b2” between the location of feature 2 in the first (x-ray) image and the location of feature 2 in the second image is 3.3 mm, so that the co-registration error of feature 2 is b2/a=3.3 mm/141 mm=0.023. Generally, feature elevations of subjects are not known during use of multi-modal electronic imaging systems for animals, and without knowledge of feature elevation, it is difficult to correct for geometric magnification in the x-ray image. As a result, for the conventional multi-modal imaging system represented in FIG. 2B, there can be a relatively large ambiguity for anatomical localization of feature 2 between first and second imaging modes.

One approach to minimize the distortion of the x-ray image is to position the microfocus x-ray source relatively far from the phosphor plate, thereby allowing use of a cone beam with a relatively low divergence angle to cover the desired field of view; however this approach requires the multi-modal electronic imaging system to have a relatively large size due to the relatively large distance needed between the microfocus x-ray source and the frame, which is undesirable.

Known multi-modal electronic imaging systems use a single microfocus x-ray source for imaging one or more animals. With this arrangement, a relatively long time is required to capture an x-ray image of desirable quality. This is because there is limited x-ray flux available from the microfocus x-ray source and this flux must be distributed across a relatively large field of view, particularly when imaging multiple animal subjects. A relatively long integration period is needed for obtaining and detecting incident photons from the phosphor plate.

The Applicants have recognized a need for an apparatus and method for enabling analytical imaging of multiple subjects in multiple modes with reduced co-registration error, while constraining the apparatus size. The Applicants have further recognized a need for an apparatus and method for analytical imaging of a plurality of subjects in different modes that reduces the image capture time necessary to achieve x-ray images having desirable image quality.

### SUMMARY OF THE INVENTION

An object of the present invention is to provide an apparatus and method for enabling analytical imaging of a plurality of subjects.

Another object of the present invention is to provide such an apparatus and method for enabling analytical imaging of a plurality of subjects in different modes, wherein the co-registration error among the differing modes is reduced over conventional approaches.

These objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

One embodiment of the invention is directed to an imaging system for imaging a plurality of immobilized subjects, wherein the plurality is comprised of at least two subjects. The system includes a support member such as a stage adapted to receive the subjects in an immobilized state, the support member including a frame optionally supporting an optically clear support element for the subjects. An imaging unit is included for imaging the immobilized subjects in a first imaging mode to capture a first image, the first imaging mode being selected from the group consisting of: x-ray mode and radio isotope mode; and for imaging the immobilized subjects in a second imaging mode that uses light from the immobilized subjects, different from the first imaging mode, to capture a second image, the second imaging mode being selected from the group consisting of: bright-field mode, fluorescence mode, and luminescence mode. A movable phosphor plate is included to transduce ionizing radiation to visible light. The phosphor plate includes a phosphor plane. The phosphor plate is mounted to be moved, while the subjects remain immobilized on the support member, between a first position proximate the support member for and during capture of the first image and a second position not proximate the support member for and during capture of the second image. A layer on the phosphor plate protects a surface of the phosphor plate facing the support element of the support member during movement of the phosphor plate between the first and second positions. A capture system is included for capturing either the first image or the second image of the subjects. A plurality of x-ray sources is included for illuminating the phosphor plate, wherein the plurality is comprised of at least two x-ray sources. The x-ray sources are microfocus x-ray sources. The plurality of x-ray sources is spatially distributed so that a corresponding plurality of zones is provided at the phosphor plane wherein each zone is illuminated by the cone beam of only the corresponding x-ray source. The plurality of subjects is also spatially distributed so that the radiograph of each object is contained in one of the zones, and at least two of the zones contain radiographs.

Another embodiment of the invention is directed to an imaging system for imaging a plurality of immobilized subjects, wherein the plurality comprises at least two subjects. An imaging unit is included for imaging the immobilized subjects in a first imaging mode to capture a first image, the first imaging mode being selected from the group consisting of: x-ray mode and radio isotope mode; and for imaging the immobilized subjects in a second imaging mode that uses light from the immobilized subjects, different from the first imaging mode, to capture a second image, the second imaging mode being selected from the group consisting of: bright-field mode, fluorescence mode, and luminescence mode. A capture system is included for capturing either the first image or the second image of the subjects. The capture system includes a sensor. A movable phosphor plate is included to transduce ionizing radiation to visible light. The phosphor plate includes a phosphor plane. The phosphor plate is mounted to be moved between a first position between the plurality of subjects and the sensor for and during capture of the first image and a second position not between the plurality of subjects and the sensor for and during capture of the second image. A plurality of x-ray sources is included for illuminating the phosphor plate, wherein the plurality is comprised of at least two x-ray sources. The x-ray sources are microfocus x-ray sources. The plurality of x-ray sources is spatially distributed so that a corresponding plurality of zones is provided at the phosphor plane wherein each zone is illuminated by the cone beam of only the corresponding x-ray source. The plurality of subjects is also spatially distributed so that the radiograph of each object is contained in one of the zones, and at least two of the zones contain radiographs.

Another embodiment of the invention is directed to an imaging system for imaging a plurality of at least two immobilized subjects. The imaging system has two capture systems. The first capture system is for capturing a first image of the immobilized subjects in a first imaging mode, the first imaging mode being selected from the group consisting of: x-ray mode and radio isotope mode. The first capture system includes an x-ray camera. The x-ray camera includes a sensor. The sensor includes a sensor plane. The second capture system is for capturing the image of the immobilized subjects in a second imaging mode that uses light from the immobilized object, different from the first imaging mode, the second imaging mode being selected from the group consisting of: bright-field mode, fluorescence mode, and luminescence mode. The second capture system includes and optical camera. The optical camera includes a sensor. The x-ray camera is movable. The x-ray camera is mounted to be moved between a first position between the plurality of subjects and the optical camera for and during capture of the first image and a second position not between the plurality of subjects and the optical camera for and during capture of the second image. A plurality of x-ray sources is included for illuminating the sensor plane, wherein the plurality is comprised of at least two x-ray sources. The x-ray sources are microfocus x-ray sources. The plurality of x-ray sources is spatially distributed so that a corresponding plurality of zones is provided at the sensor plane wherein each zone is illuminated by the cone beam of only the corresponding x-ray source. The plurality of subjects is also spatially distributed so that the radiograph of each object is contained in one of the zones, and at least two of the zones contain radiographs.

Another embodiment of the invention is directed to an imaging system for imaging a plurality of immobilized subjects, wherein the plurality is comprised of at least two subjects. The imaging system includes an x-ray recording medium. The x-ray recording medium is, for example, x-ray film. Alternatively, the x-ray recording medium is, for example, a storage phosphor screen. The x-ray recording medium is for recording a first image of the immobilized subjects in a first imaging mode, the first imaging mode being selected from the group consisting of: x-ray mode and radio isotope mode. The x-ray recording medium includes a recording plane. The imaging system also includes a capture system for capturing the image of the immobilized subjects in a second imaging mode that uses light from the immobilized object, different from the first imaging mode, the second imaging mode being selected from the group consisting of: bright-field mode, fluorescence mode, and luminescence mode. The capture system includes and optical camera. The optical camera includes a sensor. The x-ray recording medium is movable. The x-ray recording medium is mounted to be moved between a first position between the plurality of subjects and the optical camera for and during capture of the first image and a second position not between the plurality of subjects and the optical camera for and during capture of the second image. A plurality of x-ray sources is included for illuminating the recording plane, wherein the plurality is comprised of at least two x-ray sources. The x-ray sources are microfocus x-ray sources. The plurality of x-ray sources is spatially distributed so that a corresponding plurality of zones is provided at the recording plane wherein each zone is illuminated by the cone beam of only the corresponding x-ray source. The plurality of subjects is also spatially distributed so that the radiograph of each object is contained in one of the zones, and at least two of the zones contain radiographs.

According to an aspect of the present invention there is provided an imaging system for imaging at least a first and a second subject, the system comprising: a support stage adapted to support the at least first and second subjects; an imaging system comprising: an ionizing radiation imaging section that comprises: at least a first ionizing radiation source energizable for directing ionizing radiation toward the support stage and within a first zone that includes at least a portion of the first subject and a second ionizing radiation source energizable for directing ionizing radiation within a second zone that lies substantially outside the first zone and that includes at least a portion of the second subject; at least one imaging receiver that forms a radiation image of the subject within each zone according to incident ionizing radiation; a camera system energizable to obtain at least one illumination image of the at least first and second subjects; and a computer in signal communication with the imaging system and energizable to form a combined image from the radiation image and the illumination image of the same subjects obtained from the imaging system.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1A shows a perspective view of a known electronic imaging system including a removable phosphor screen.

FIG. 1B shows a diagrammatic side view of the imaging system of FIG. 1A.

FIG. 1C shows a diagrammatic front view of the imaging system of FIG. 1A.

FIG. 1D shows a detailed perspective view of the imaging system of FIG. 1A.

FIG. 2A shows a geometric representation of the co-registration error present in the imaging system of FIG. 1A.

FIG. 2B shows a close-up view of FIG. 2A.

FIG. 3A shows a diagrammatic front view of an imaging system in accordance with a first embodiment of the present invention.

FIG. 3B shows a diagrammatic front view of an imaging system in accordance with a second embodiment of the present invention.

FIG. 4A shows a diagrammatic front view of an imaging system in accordance with a third embodiment of the present invention.

FIG. 4B shows a diagrammatic front view of an imaging system in accordance with a fourth embodiment of the present invention.

FIG. 4C shows a diagrammatic front view of an imaging system that employs a digital receiver (DR) panel for forming an image of each subject.

FIG. 5A shows a diagrammatic side view of the sample object stage in accordance with the first embodiment of the present invention.

FIG. 5B shows a diagrammatic side view of the sample object stage of FIG. 5A in the first imaging position P1 wherein the phosphor plate is disposed proximate the sample object stage.

FIG. 5C shows a diagrammatic side view of the sample object stage of FIG. 5A in the second imaging position P2 wherein the phosphor plate is not proximate the sample object stage.

FIG. 6 shows an enlarged, fragmentary sectional view taken along line 6-6 of FIG. 5B.

FIG. 7 shows an enlarged, fragmentary sectional view taken along line 7-7 of FIG. 5C.

FIG. 8A shows a geometric representation of the improved co-registration error for an embodiment of an imaging system in accordance with the present invention.

FIG. 8B shows an enlarged view of portions of FIG. 8A.

FIG. 8C shows a work flow diagram in accordance with a method of the present invention.

FIG. 9A shows a first image of two immobilized subjects in a first imaging mode.

FIG. 9B shows a second image of the immobilized subjects of FIG. 9A in a second imaging mode.

FIG. 9C shows an image generated by the merger of the images of FIGS. 9A and 9B.

FIG. 10 is a diagrammatic view of a suitable phosphor plate for use with the apparatus and method of the present invention.

FIG. 11 is a flow diagram of a method for making a phosphor plate of FIG. 10.

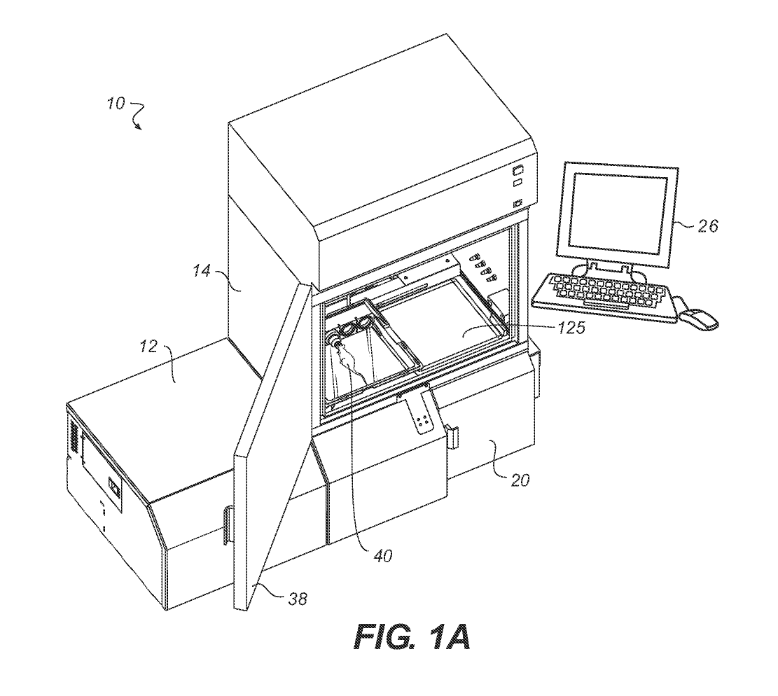

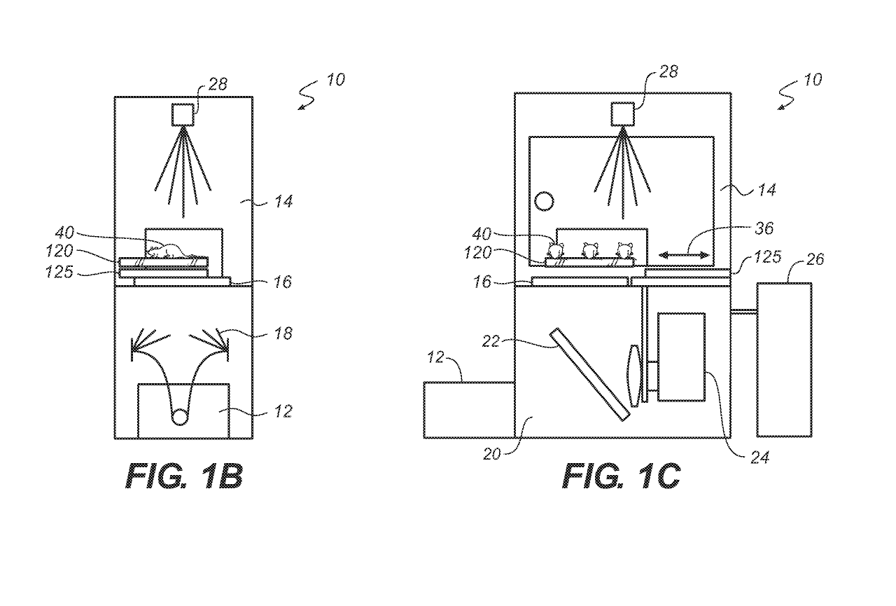

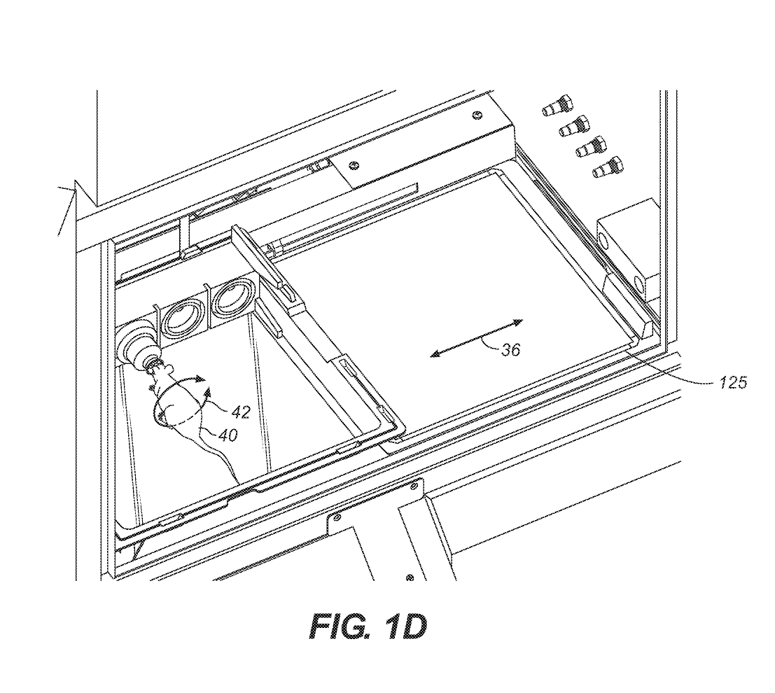

### DETAILED DESCRIPTION OF THE INVENTION

The following is a detailed description of the preferred embodiments of the invention, reference being made to the drawings in which the same reference numerals identify the same elements of structure in each of the several figures. Where they are used, the terms “first”, “second”, and so on, do not necessarily denote any ordinal, sequential, or priority relation, but are simply used to more clearly distinguish one element or set of elements from another, unless specified otherwise.

Reference is made to U.S. Ser. No. 12/196,300 filed Aug. 22, 2008 by Harder et al, entitled APPARATUS AND METHOD FOR MULTI-MODAL IMAGING USING NANOPARTICLE MULTI-MODAL IMAGING PROBES, which published as US 2009/0086908.

Reference is made to U.S. Ser. No. 12/354,830 filed Jan. 16, 2009 by Feke et al, entitled APPARATUS AND METHOD FOR MULTI-MODAL IMAGING, which granted as U.S. Pat. No. 8,050,735.

Reference is made to U.S. Ser. No. 12/381,599 filed Mar. 13, 2009 by Feke et al, entitled METHOD FOR REPRODUCING THE SPATIAL ORIENTATION OF AN IMMOBILIZED SUBJECT IN A MULTI-MODAL IMAGING SYSTEM, which published as US 2009/0238434.

Reference is made to U.S. Ser. No. 12/475,623 filed Jun. 1, 2009 by Feke et al, entitled TORSIONAL SUPPORT APPARATUS AND METHOD FOR CRANIOCAUDAL ROTATION OF ANIMALS, which published as US 2010/0022866.

In the context of the present disclosure, the terms “subject” and “object” may be used interchangeably when used with regard to the living or inanimate entity that is being imaged.

In the context of the present disclosure, a distinction is made between ionizing radiation and illumination. “Ionizing radiation” includes x-rays and gamma rays, for example, that have sufficient energy to cause ionization in the medium through which they are transmitted and, as the term is generally used with respect to imaging functions, includes radiation of wavelengths of less than about 10 nm. “Illumination” includes light in the visible range and beyond, a wavelength band extending from non-ionizing radiation in the ultraviolet (UV) light region to light radiation in the infrared range below about 10 μm. Embodiments of the present invention provide multi-modal imaging that employs both ionizing radiation and illumination for imaging, with suitable components for providing the needed radiation energy or illumination and for obtaining the image data according to the provided energy. The image obtained from ionizing radiation may be termed the radiation image. The image obtained using illumination may be termed the illumination image. The act of forming an image may include display of the image or storage of image data in a computer-accessible memory, such as for further processing or archival, for example.

In the context of the present disclosure, the term “energizable” relates to a device or set of components that perform an indicated function upon receiving power and, optionally, upon receiving an enabling signal. The term “actuable” has its conventional meaning, relating to a device or component that is capable of effecting an action in response to a stimulus, such as in response to an electrical signal or to a manually applied force, for example.

The applicants have recognized that the complex pharmaceutical analyses of small objects/subjects (e.g., small animal and tissue) images are particularly enhanced by using different in-vivo imaging modalities. Using the known/current practices of bright-field, dark-field and radiographic imaging for the analysis of small objects/subjects (such as mice) may not provide the precision of co-registered images that is desired.

Using the apparatus and method of the present invention, precisely co-registered fluorescent, luminescent and/or isotopic probes within subjects (e.g., live animals and tissue) can be localized and multiple images can be accurately overlaid onto the simple bright-field reflected image or anatomical x-ray of the same animals within minutes of animal immobilization.

The present invention uses the same imaging system to capture different modes of imaging, thereby enabling and simplifying multi-modal imaging. In addition, the relative movement of probes can be kinetically resolved over the time period that the animal is effectively immobilized (which can be tens of minutes). Alternatively, the same animals may be subject to repeated complete image analysis over a period of days/weeks required to assure completion of a pharmaceutical study, with the assurance that the precise anatomical frame of reference (particularly, the x-ray) may be readily reproduced upon repositioning the object animals. The method of the present invention can be applied to other objects and/or complex systems subject to simple planar imaging methodologies.

More particularly, using the imaging system of the present invention, two or more immobilized subjects can be imaged in several imaging modes and the acquired multi-modal images can then be merged to provide, for each subject, one or more co-registered images for analysis.

Imaging modes supported by the apparatus/method of the present invention include modes that use various types of ionizing radiation and illumination. In embodiments of the present invention, images obtained using ionizing radiation, termed “radiation images” can be from a subject that is externally irradiated, such as using an x-ray source. The image can be formed in intermediate form on a phosphor screen, for example, and can then be captured by a camera or other sensor. Images obtained using illumination that is externally provided, termed “illumination images”, include conventional dark field or bright field images and fluorescence images for subjects and materials that emit a fluorescent wavelength in respond to an excitation wavelength. Another type of illumination image supported by the apparatus of the present invention is obtained from a subject for which no external illumination is provided, so-called luminescence images that use light generated from within the imaged subject. The same camera that is used where illumination is provided also serves for obtaining a luminescence image. Yet another type of image that is optionally supported by apparatus of embodiments of the present invention is a radio-isotopic image, formed from sensing a radioactive material that has been ingested, injected, absorbed, or otherwise received internally by a subject.

Images acquired in these modes can be merged in various combinations for analysis. For example, the radiation image, an x-ray image of the subjects, can be merged with an illumination image, such as a near-infrared fluorescence image of the subjects, to provide a new image for analysis.

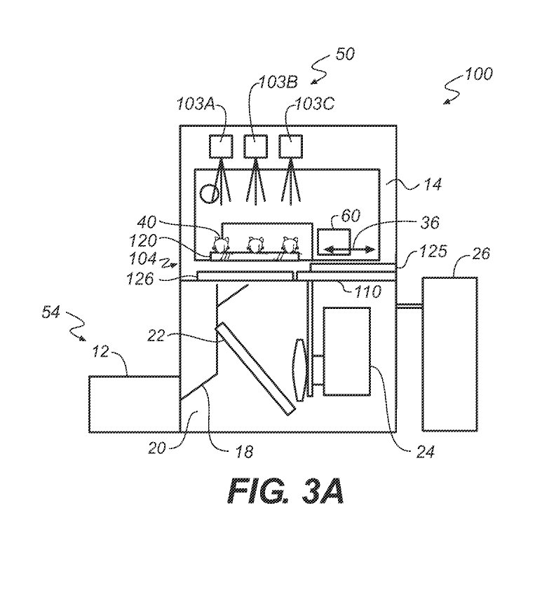

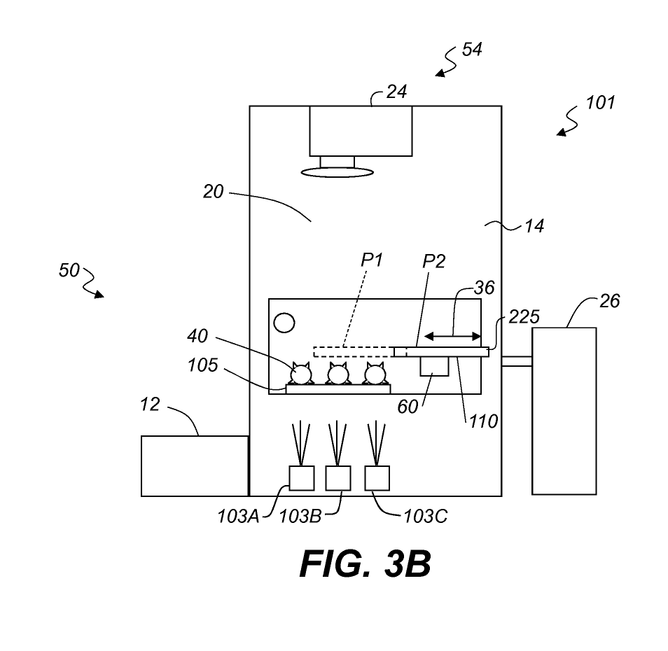

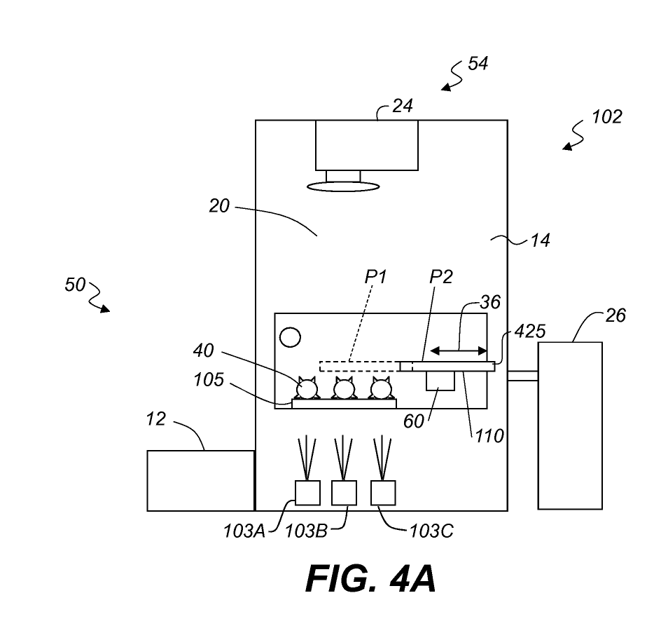

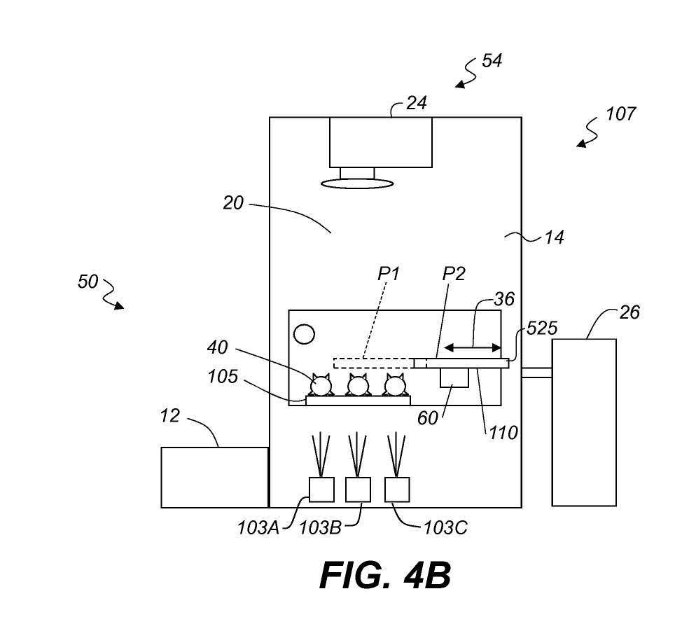

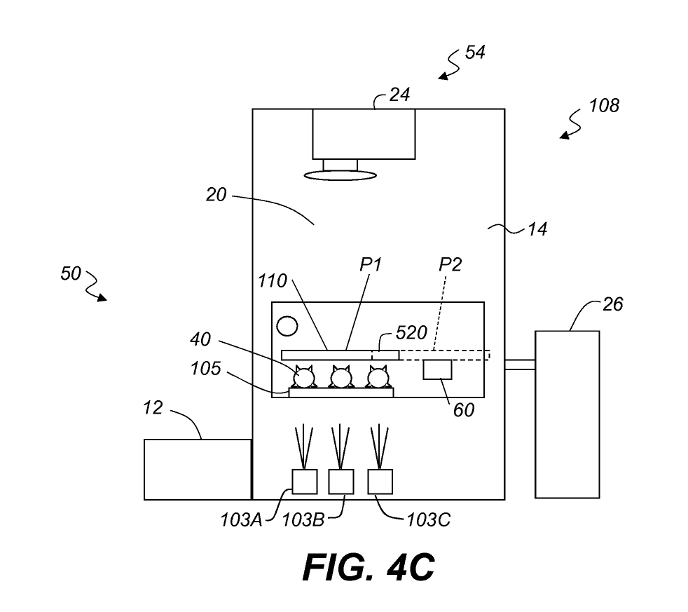

The apparatus of the present invention is now described with reference to the embodiments shown in FIGS. 3A, 3B, 4A, 4B, and 4C.

FIG. 3A shows a diagrammatic front view of an imaging system 100 in accordance with one embodiment of the present invention. Imaging system 100 includes a light source 12, sample environment 14, optical compartment 20, a lens/camera system 24, movable phosphor plate 125 as an imaging receiver 110, and communication/computer control system 26 which can include a display device, for example, a computer monitor. Camera/lens system 24 can include an emission filter wheel for fluorescence imaging. Light source 12 is optional and can include an excitation filter selector for fluorescent excitation or bright field color imaging. Imaging system 100 includes an ionizing radiation imaging section 50 that has a plurality of (for example, but not limited to, three) x-ray sources 103A, 103B, and 103C, and a support member such as a sample object support stage 104, also termed an object stage in the present disclosure. Each of the x-ray sources 103A, 103B, and 103C has a corresponding zone on sample object support stage 104 that receives its radiation; neighboring zones are substantially non-overlapping with respect to the subjects and support stage. Two adjacent or neighboring zones are considered to be substantially non-overlapping wherein each corresponding x-ray source provides radiation to the subject that is within its own zone and there is negligible or no radiation from the source for one zone that is incident upon the subject in its neighboring zone. A transport apparatus 60 is actuable to manually or automatically translate, rotate, or otherwise move the imaging receiver for ionizing radiation imaging, phosphor plate 125 in the embodiment shown, between at least a first imaging position and a second imaging position. This movement is indicated by an arrow 36 and is described in more detail subsequently. A plurality of immobilized subjects such as mice 40 are received on and supported by a sample object stage 104 during operation of system 100. Imaging system 100 further comprises an optional light imaging section 54 that has an illumination source 12 that is energizable for providing light for imaging the plurality of subjects 40. Imaging system 100 also has a lens and camera system 24 for obtaining an image from the subjects 40 according to the type of illumination that is generated or received. Camera system 24 may obtain an image of the subjects 40 directly, or may obtain an image from phosphor plate 125 or other imaging receiver that forms an intermediate image of the subjects according to the ionizing radiation. According to an embodiment of the present invention, light imaging section 54 provides epi-illumination, for example, using fiber optics, which directs conditioned light (of appropriate wavelength and divergence) toward sample object stage 104 to provide bright-field or fluorescence imaging.

Sample object support stage 104 is disposed within sample environment 14, which allows access to the object being imaged. Preferably, sample environment 14 is light-tight and fitted with light-locked gas ports (not illustrated) for environmental control. Environmental control enables practical x-ray contrast below 8 Key (air absorption) and aids in life support for biological specimens. Such environmental control might be desirable for controlled x-ray imaging or for support of particular specimens.

Imaging system 100 can include an access means/member to provide convenient, safe and light-tight access to sample environment 14, such as a door, opening, labyrinth, and the like. Additionally, sample environment 14 is preferably adapted to provide atmospheric control for sample maintenance or soft x-ray transmission (e.g., temperature/humidity/alternative gases and the like). A communication and computer control system 26 has a computer that is in signal communication with the imaging system and is energizable to combine a first image obtained from the ionizing radiation imaging section with a second image obtained from the light imaging section to form a combined image for display and for storage in a computer-accessible memory, such as on-board memory in communication and computer control system 26.

The embodiment shown in FIG. 3B is similar to that shown in FIG. 3A with a different arrangement of imaging components. FIG. 3B shows a diagrammatic front view of an imaging system 101 in accordance with another embodiment of the present invention. Imaging system 101 includes an optional illumination source 12, sample environment 14, a lens/camera system 24, movable phosphor plate 225 as the imaging receiver, and communication/computer control system 26 which can include a display device, for example, a computer monitor. Camera/lens system 24 in optical compartment 20 can include an emission filter wheel for fluorescence imaging. Illumination source 12 can include an excitation filter selector for fluorescent excitation or bright field color imaging. Imaging system 101 includes an ionizing radiation imaging section 50 that has a plurality of (for example, but not limited to, three) x-ray sources 103A, 103B, and 103C, and a support member such as a sample object support stage 105. Optional transport apparatus 60 is actuable to translate, rotate, or otherwise move imaging receiver 110 for ionizing radiation imaging, a phosphor plate 225, between at least a first imaging position P1 and a second imaging position P2, as indicated by arrow 36 and as described in more detail subsequently. A plurality of immobilized subjects such as mice 40 are received on and supported by sample object stage 105 during operation of system 101. Imaging system 101 further comprises an optional light imaging section 54 that has illumination source 12 for providing light for imaging the plurality of subjects 40. Imaging system 100 also has lens and camera system 24 for obtaining an image from the subjects 40 according to the illumination that is received or generated from luminescence. According to an embodiment of the present invention, light imaging section 54 provides epi-illumination, for example, using fiber optics, which directs conditioned light (of appropriate wavelength and divergence) toward sample object stage 105 to provide bright-field or fluorescence imaging.

Still referring to FIG. 3B, sample object support stage 105 is disposed within a sample environment 14, which allows access to the subject being imaged. Preferably, sample environment 14 is light-tight and fitted with light-locked gas ports (not illustrated) for environmental control. Environmental control enables practical x-ray contrast below 8 Key (air absorption) and aids in life support for biological specimens. Such environmental control might be desirable for controlled x-ray imaging or for support of particular specimens.

Imaging system 101 can include an access means/member to provide convenient, safe and light-tight access to sample environment 14, such as a door, opening, labyrinth, and the like. Additionally, sample environment 14 is preferably adapted to provide atmospheric control for sample maintenance or soft x-ray transmission (e.g., temperature/humidity/alternative gases and the like). Communication and computer control system 26 has a computer that is in signal communication with the imaging system and is energizable to combine a first image obtained from the ionizing radiation imaging section with a second image obtained from the light imaging section to form a combined image.

Phosphor plate 225 in the FIG. 3B embodiment may simply be an upside-down version of phosphor plate 125 described above with reference to FIG. 3A. Phosphor plate 225 is mounted for motion toward and away from sample object support stage 105. While those skilled in the art might recognize other configurations, in a preferred embodiment, phosphor plate 225 is mounted for translation to provide slidable motion relative to sample object stage 105, above the plurality of subjects 40. Such motion can be accomplished using methods known to those skilled in the art, for example, phosphor plate 225 can be disposed on rails, or alternatively pivot around a shaft. As will be more particularly described below, in a first imaging position P1, phosphor layer 230 in phosphor plate 225 is in overlapping arrangement with sample object stage 105 when an x-ray image of the subjects is captured by lens/camera system 24. In second imaging position P2, phosphor plate 225 is translated/moved away from sample object stage 105 for capture of an image of the subjects by lens/camera system 24 such that phosphor plate 225 is not imaged when an image of the subjects is captured in second imaging position P2.

FIG. 4A shows a diagrammatic front view of an imaging system 102 in accordance with another embodiment of the present invention. Imaging system 102 includes optional illumination source 12, sample environment 14, a lens/camera system 24, a movable x-ray camera 425 as imaging receiver 110, and communication/computer control system 26 which can include a display device, for example, a computer monitor. Camera/lens system 24 can include an emission filter wheel for fluorescence imaging. Illumination source 12 can include an excitation filter selector for fluorescent excitation or bright field color imaging. Imaging system 102 includes ionizing radiation imaging section 50 that has a plurality of (for example, but not limited to, three) x-ray sources 103A, 103B, and 103C, and a support member such as a sample object support stage 105, also referred to herein as an object stage. Optional transport apparatus 60 is actuable to translate, rotate, or otherwise move the imaging receiver for ionizing radiation imaging, movable x-ray camera 425, between at least a first imaging position P1 and a second imaging position P2, as indicated by arrow 36 and as described in more detail subsequently. A plurality of immobilized subjects such as mice 40 are received on and supported by sample object stage 105 during operation of system 102. Imaging system 102 further comprises optional light imaging section 54 that has illumination source 12 for providing light for imaging the plurality of subjects 40 according to the type of illumination that is generated or received. Camera system 24 may obtain an image from the subjects 40 directly, according to the illumination that is received from illumination source 12, generated from luminescence, generated using radio-isotope materials, or generated from incident radiation. According to an embodiment of the present invention, light imaging section 54 provides epi-illumination, for example, using fiber optics, which directs conditioned light (of appropriate wavelength and divergence) toward sample object stage 105 to provide bright-field or fluorescence imaging.

Still referring to FIG. 4A, sample object stage 105 is disposed within a sample environment 14, which allows access to the subjects being imaged. Preferably, sample environment 14 is light-tight and fitted with light-locked gas ports (not illustrated) for environmental control. Environmental control enables practical x-ray contrast below 8 Key (air absorption) and aids in life support for biological specimens. Such environmental control might be desirable for controlled x-ray imaging or for support of particular specimens.

Imaging system 102 can include an access means/member to provide convenient, safe and light-tight access to sample environment 14, such as a door, opening, labyrinth, and the like. Additionally, sample environment 14 is preferably adapted to provide atmospheric control for sample maintenance or soft x-ray transmission (e.g., temperature/humidity/alternative gases and the like). Communication and computer control system 26 has a computer that is in signal communication with the imaging system and is energizable to combine a first image obtained from the ionizing radiation imaging section with a second image obtained from the light imaging section to form a combined image.

In the FIG. 4A embodiment, X-ray camera 425 serves as imaging receiver 110 that forms an image of the subject within each zone according to incident ionizing radiation. X-ray camera 425 is, for example, an x-ray time-delay integration scanning camera such as the known camera described in the product brochure for Hamamatsu Photonics K.K., Systems Division catalog number SFAS0020E07, dated March 2010, entitled “X-ray TDI Camera”. Alternatively, x-ray camera 425 is, for example, an x-ray line scan camera such as the known camera described in the product brochure for Hamamatsu Photonics K.K., Systems Division catalog number SFAS0017E06, dated June 2010, entitled “X-ray Line Scan Camera”. Alternatively, x-ray camera 425 is, for example, a flat panel x-ray detector as known to those skilled in the art. Alternatively, x-ray camera 425 is, for example, a fluoroscopic x-ray detector as known to those skilled in the art. Those skilled in the art might recognize other suitable x-ray cameras. X-ray camera 425 is mounted for motion toward and away from sample object stage 105 by transport apparatus 60. While those skilled in the art might recognize other configurations, in a preferred embodiment, x-ray camera 425 is mounted for translation to provide slidable motion relative to sample object stage 105, above the plurality of subjects 40. Such motion can be accomplished using methods known to those skilled in the art, for example, x-ray camera 425 can be disposed on rails, or alternatively pivot around a shaft. As will be more particularly described below, in a first imaging position P1, x-ray camera is in overlapping arrangement with sample object stage 105 when an x-ray image of the subjects is captured by x-ray camera 425. In second imaging position P2, x-ray camera 425 is translated/moved away from sample object stage 105 for capture of an image of the subjects by lens/camera system 24 such that x-ray camera 425 does not obstruct imaging when an image of the subjects is captured in second imaging position P2. In an alternate embodiment, x-ray camera 425 is indexed to a successive position for acquiring the radiation image of each successive subject, respectively, as the subject is irradiated. Thus, for example, x-ray camera 425 is indexed to a first position and a radiation image is acquired or obtained of the first subject within a first zone; then, x-ray camera 425 is indexed to a second position for imaging the second subject in a second zone, and in like manner to one or more subsequent positions for imaging each subsequent subject in a corresponding zone. Alternately, the support stage is indexed to position each subject, in sequence, within the zone irradiated, and to acquire or obtain the radiation image using a stationary x-ray camera 425.

A particular advantage of using a plurality of x-ray sources with a scanning x-ray camera such as an x-ray time delay integration camera or an x-ray line scan camera is that the scan direction of the scanning x-ray camera can be oriented to be generally in parallel with the axis on which the plurality of x-ray sources is distributed, so that the x-ray sources can turn on and off, or equivalently be blocked and unblocked, in synchronization with the scanning motion of the scanning x-ray camera so that each x-ray source only exposes the corresponding zone at the time when the scanning x-ray camera is in registration with the particular zone. The advantage is that the x-ray dose delivered to each animal within each zone is reduced relative to the case where the x-ray sources are constantly exposing the animals during image capture even when the scanning x-ray camera is not imaging the subset of zones corresponding to a subset of the animals.

FIG. 4B shows a diagrammatic front view of an imaging system 107 in accordance with another embodiment of the present invention. Imaging system 107 includes optional illumination source 12, sample environment 14, a lens/camera system 24, movable x-ray recording medium 525, and communication/computer control system 26 which can include a display device, for example, a computer monitor. Camera/lens system 24 can include an emission filter wheel for fluorescence imaging. Illumination source 12 can include an excitation filter selector for fluorescent excitation or bright field color imaging. Imaging system 107 includes ionizing radiation imaging section 50 that has a plurality of (for example, but not limited to, three) x-ray sources 103A, 103B, and 103C, and a support member such as a sample object stage 105. Transport apparatus 60 is manually or automatically actuable to translate, rotate, or otherwise move the imaging receiver for ionizing radiation imaging, movable x-ray camera 425, between at least a first imaging position P1 and a second imaging position P2, as indicated by arrow 36 and as described in more detail subsequently. A plurality of immobilized subjects such as mice 40 are received on and supported by sample object stage 105 during operation of system 107. Imaging system 107 further comprises optional light imaging section 54 that has illumination source 12 for providing light for imaging the plurality of subjects 40. Imaging system 107 further has lens and camera system 24 for obtaining an image from the subjects 40 according to the illumination that is received or formed from incident radiation. According to an embodiment of the present invention, light imaging section 54 provides epi-illumination, for example, using fiber optics, which directs conditioned light (of appropriate wavelength and divergence) toward sample object stage 105 to provide bright-field or fluorescence imaging.

Sample object stage 105 is disposed within a sample environment 14, which allows access to the subjects being imaged. Preferably, sample environment 14 is light-tight and fitted with light-locked gas ports (not illustrated) for environmental control. Environmental control enables practical x-ray contrast below 8 Key (air absorption) and aids in life support for biological specimens. Such environmental control might be desirable for controlled x-ray imaging or for support of particular specimens. Imaging system 107 can include an access means/member to provide convenient, safe and light-tight access to sample environment 14, such as a door, opening, labyrinth, and the like. Additionally, sample environment 14 is preferably adapted to provide atmospheric control for sample maintenance or soft x-ray transmission (e.g., temperature/humidity/alternative gases and the like). Communication and computer control system 26 has a computer that is in signal communication with the imaging system and is energizable to combine a first image obtained from the ionizing radiation imaging section with a second image obtained from the light imaging section to form a combined image.

X-ray recording medium 525 is, for example, known x-ray film used as imaging receiver 110. Alternatively, x-ray recording medium 525 is, for example, a known storage phosphor screen. Those skilled in the art might recognize other suitable x-ray recording media. X-ray recording medium 525 is mounted for motion toward and away from sample object stage 105. While those skilled in the art might recognize other configurations, in a preferred embodiment, x-ray recording medium 525 is mounted for translation by transport apparatus 60 to provide slidable motion relative to sample object stage 105, above the plurality of subjects 40. Such motion can be accomplished using methods known to those skilled in the art, for example, x-ray recording medium 525 can be disposed on rails, or alternatively pivot around a shaft. As will be more particularly described below, in a first imaging position P1, x-ray recording medium is in overlapping arrangement with sample object stage 105 when an x-ray image of the subjects is recorded by x-ray recording medium 525. In second imaging position P2, x-ray recording medium 525 is translated/moved away from sample object stage 105 for capture of an image of the subjects by lens/camera system 24 such that x-ray recording medium 525 does not obstruct imaging when an image of the subjects is captured in second imaging position P2.

FIG. 4C shows an imaging system 108 in an alternate embodiment of the present invention that employs a digital receiver (DR) panel 520 as imaging receiver 110 for forming an image of each subject. Digital receiver panel 520 uses an array of imaging sensors to form the radiation image and provide two-dimensional image data without requiring lens and camera system 24 or other external camera. DR panel 520 is shown in two positions P1 and P2; alternately, DR panel 520 can be indexed into successive positions for imaging each individual subject 40 in sequence, allowing use of a smaller DR panel 520. Other system components for the FIG. 4C embodiment are similar to those shown in FIGS. 4A and 4B.

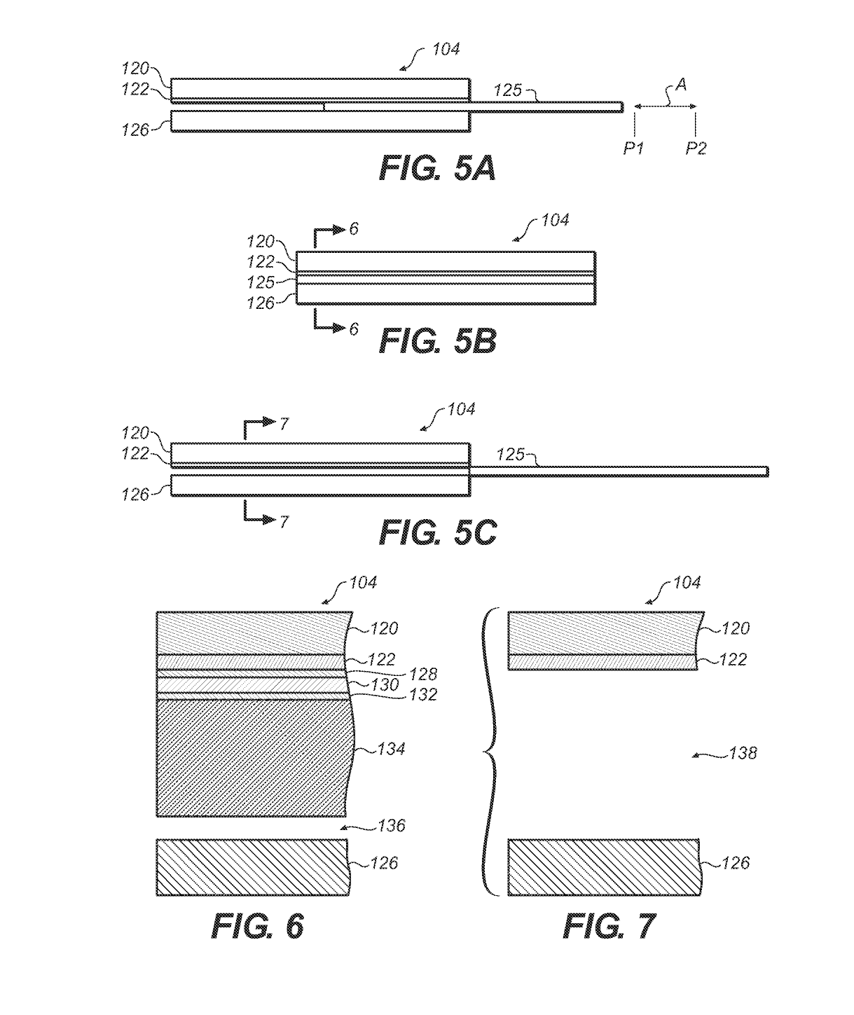

FIGS. 5-7 more particularly illustrate elements of sample object stage 104 and an optical interface relative with the focal plane of camera/lens system 24 when a phosphor plate is used as the imaging receiver. FIG. 5A shows a diagrammatic side view of sample object stage 104 showing the relative movement of a movable phosphor plate 125 as the imaging receiver relative to the sample object stage. FIG. 5B shows a diagrammatic side view of the sample object stage in a first imaging position P1 wherein the phosphor plate 125 is disposed proximate the sample object stage and positioned for imaging light from a phosphor layer 130, shown in FIG. 6. FIG. 5C shows a diagrammatic side view of the sample object stage in the second imaging position P2 wherein phosphor plate 125 has been withdrawn to a position that is not proximate the sample object stage. FIG. 6 shows an enlarged, fragmentary sectional view taken along line 6-6 of FIG. 5B, which corresponds with the first imaging position P1. FIG. 7 shows an enlarged, fragmentary sectional view taken along line 7-7 of FIG. 5C, which corresponds with the second imaging position P2.

Continuing with regard to FIGS. 6 and 7, sample object support stage 104 includes a support member made up from an open frame 120 to support and stretch a thin plastic support sheet 122. Support sheet 122 is selected so as to support the weight of a sample or object to be imaged and is made from a material that is x-ray transparent, optically clear and free of significant interfering fluorescence.

The imaging receiver, phosphor plate 125, is mounted for motion toward and away from sample object stage 104, with this motion controlled by optional transport apparatus 60 (FIGS. 3A-4C). While those skilled in the art might recognize other configurations, in a preferred embodiment, phosphor plate 125 is mounted for translation to provide slidable motion (in the direction of arrow A in FIG. 5A) relative to frame 120, beneath the plurality of subjects, in intimate contact with support sheet 122. Such motion can be accomplished using methods known to those skilled in the art, for example, phosphor plate 125 can be disposed on rails supported by a surface of an optical platen 126, or alternatively pivot around a shaft. As will be more particularly described below, in a first imaging position P1, phosphor layer 130 in phosphor plate 125 is in overlapping arrangement with sample object stage 104 (FIG. 6) when an x-ray image of the subjects is captured by lens/camera system 24. In second imaging position P2, phosphor plate 125 is translated/moved away from sample object stage 104 (FIG. 7) for capture of an image of the subjects by lens/camera system 24 such that phosphor plate 125 is not imaged when an image of the subjects is captured in second imaging position P2.

FIG. 6 provides an enlarged view of sample object stage 104 including phosphor plate 125 to more particularly show a focal plane. Sample support sheet 122 preferably comprises Mylar or polycarbonate and has a nominal thickness of about 0.1 mm. A protective layer 128 (for example, reflective Mylar) of about 0.025 mm is provided to protect the phosphor surface of phosphor plate 125. Protective layer 128 promotes/increases the image-forming light output. In a preferred embodiment, protective layer 128 is reflective so as to prevent object reflection back into the image-forming screen, reducing possible confusion in the ionizing radiation image.

Phosphor layer 130 functions to transduce ionizing radiation to visible light that can be practically managed by lens and camera system 24 (such as a CCD camera). Phosphor layer 130 can have a thickness ranging from about 0.01 mm to about 0.1 mm, depending upon the application (i.e., soft x-ray, gamma-ray or fast electron imaging). On the underside of phosphor layer 130, as illustrated, an optical layer 132 is provided for conditioning emitted light from phosphor layer 130. Optical layer 132 can have a thickness in the range of less than about 0.001 mm. Particular information about phosphor layer 130 and optical layer 132 are disclosed in U.S. Pat. No. 6,444,988 (Vizard), commonly assigned and incorporated herein by reference. A supporting glass plate 134 is provided. Glass plate 134 is spaced at a suitable mechanical clearance from an optical platen 126, for example, by an air gap/void 136. In the preferred embodiment, the surfaces of clear optical media (e.g., a lower surface of glass plate 134 and both surfaces of optical platen 126) are provided with an anti-reflective coating to minimize reflections that may confuse the image of the subject.

FIG. 7 provides an expanded view of sample object support stage 104 including wherein phosphor plate 125 is removed (i.e., taken along line 7-7 of FIG. 5C). As shown in FIG. 7 is frame 120, sample support sheet 122, an air gap/void 138 (since phosphor plate 125 is removed), and optical platen 126. Another known example of the construction of phosphor plate 125 involves deposited layers of scintillating material, such as cesium iodide and terbium-activated gadolinium oxysulfide, on aluminum or amorphous carbon substrates; examples of which are described in U.S. Pat. Nos. 6,531,225 and 6,762,420, and Hamamatsu Photonics K.K., Electron Tube Division publication number TMCP1031E04, dated June 2009, entitled “X-ray Scintillator”.

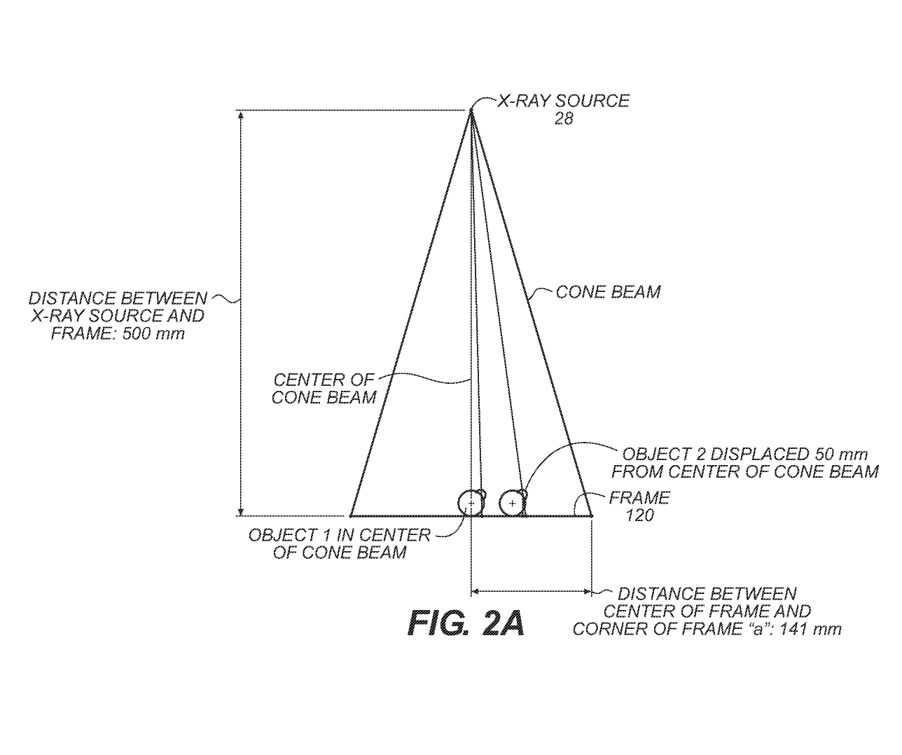

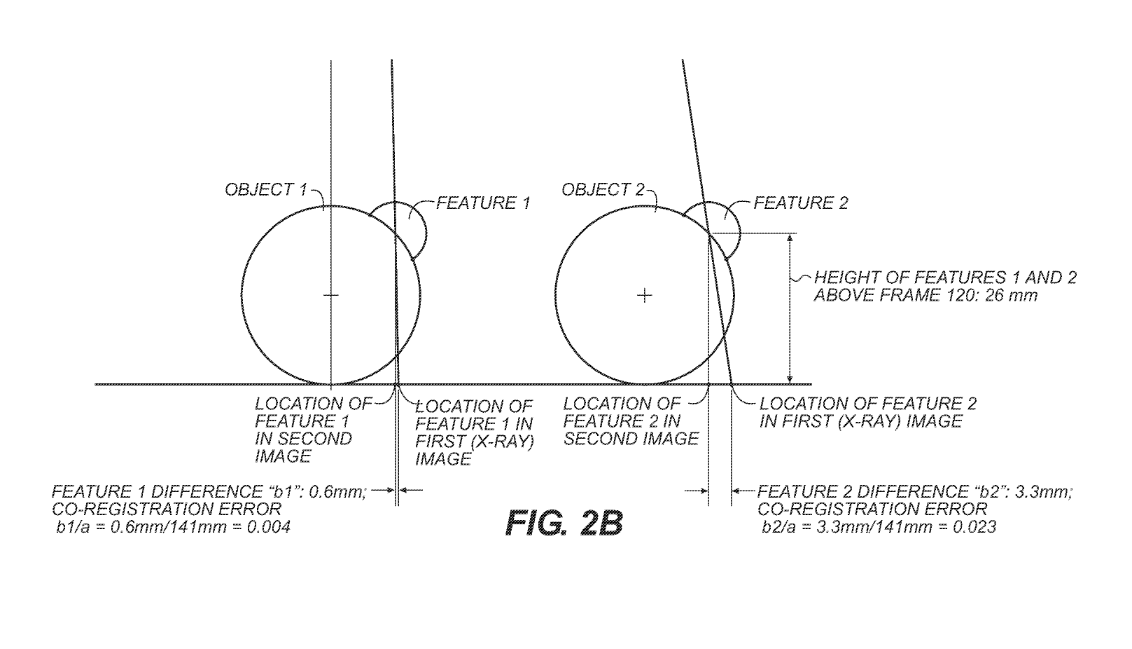

Consistent with an embodiment of the present invention, x-ray sources 103A, B, and C are microfocus x-ray sources. The x-ray sources 103A, B, and C are spatially distributed so that a corresponding plurality of zones is provided at the phosphor plane of phosphor plate 125 or 225, of imaging systems 100 or 101, respectively, or sensor plane of x-ray camera 425 of imaging system 102, or recording plane of x-ray recording medium 525 of imaging system 107, wherein, with respect to the subjects for imaging, the cone beam emitted from each x-ray source 103A, B, and C is incident only on the subject within its corresponding zone, and not on subjects in the other zones. The plurality of two or more subjects 40 is also spatially distributed so that the radiograph of each subject is contained in only one of the zones, and at least two of the zones contain radiographs. The distance of the plurality of x-ray sources 103A, B, and C from the sample object support stage 104 or 105 is such that the co-registration error between the x-ray image of the first imaging mode and the image of the second imaging mode, described earlier with reference to FIG. 2B, is preferably less than 0.02, and more preferably less than 0.01.

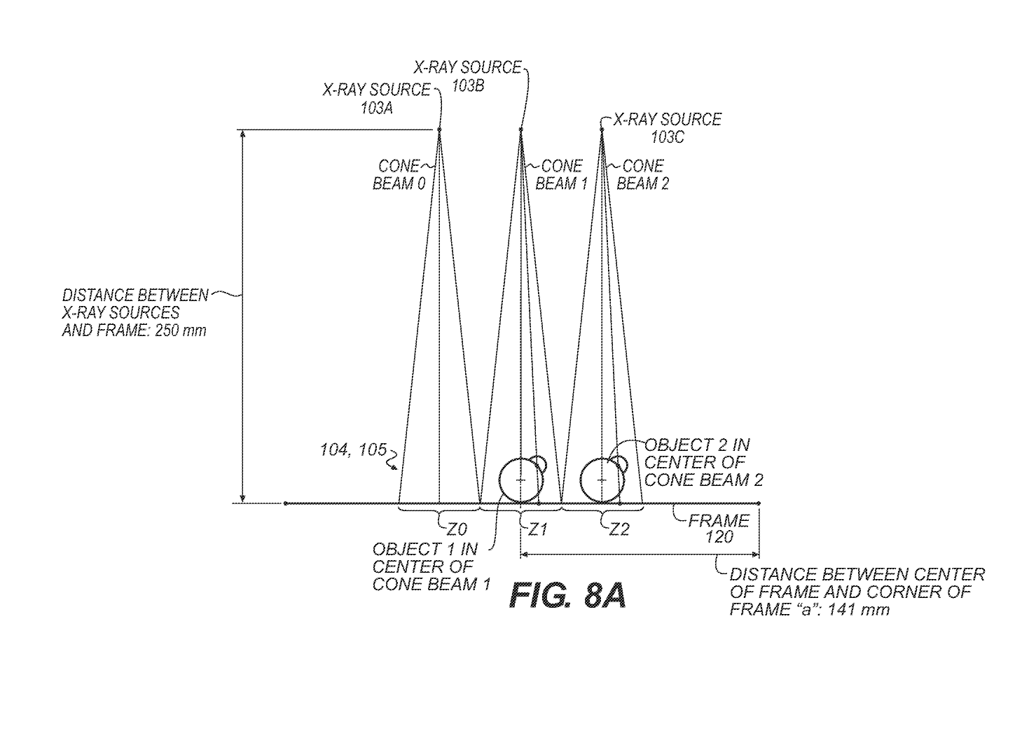

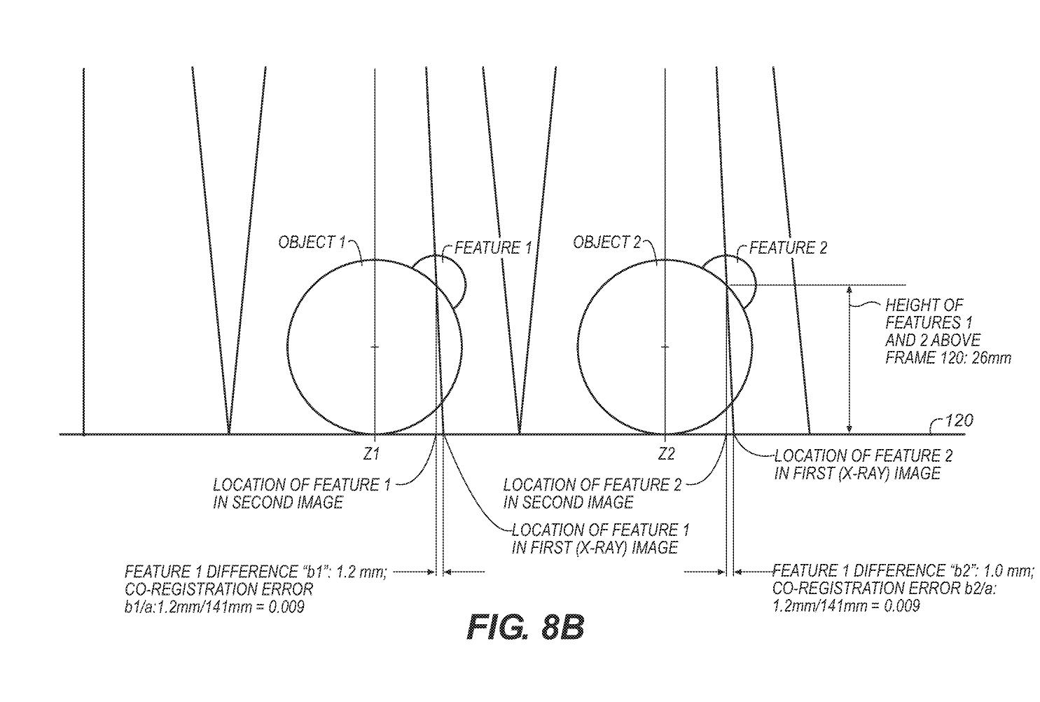

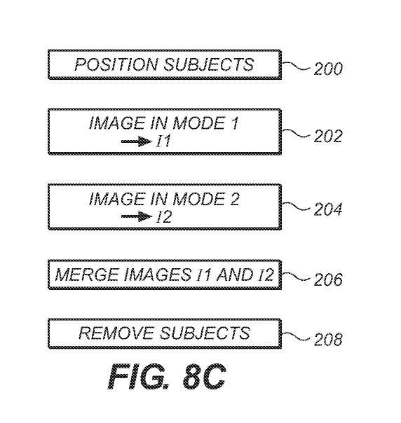

FIGS. 8A and 8B illustrate the improved co-registration error of imaging system 100 over that described earlier with respect to FIGS. 2A and 2B, which is exemplary of the improved co-registration error of the present invention. The semi-diagonal dimension of frame 120 is 141 mm. The distance between x-ray sources 103A, B, and C, and frame 120 is about 250 mm.

The cone beams from the x-ray sources cover the plurality of subjects in each of three respective zones Z0, Z1, and Z2 defined by the geometry of the cone of radiation that is emitted toward the subjects on the support stage from x-ray sources 103A, 103B, and 103C, respectively. Each of the zones lies substantially outside the other zones with respect to the subjects and support stage 104 or 105 that includes frame 120; the zones are substantially non-overlapping. Two adjacent or neighboring zones are considered to be substantially non-overlapping wherein each corresponding x-ray source provides radiation to the subject that is within its own zone and there is negligible or no radiation from the source for one zone that is incident upon the subject in its neighboring zone.

The subject labeled Object 1 is positioned in a zone Z1 in the center of the cone beam 1. The subject labeled Object 2 is positioned in a zone Z2 in the center of the cone beam 2. The respective zones include at least the imaged portion of the immobilized subject 40. The position corresponding to cone beam 0, in zone Z0 on the support stage, is unoccupied. Features 1 and 2 are part of subjects 1 and 2, respectively, and have centers which are elevated 26 mm above frame 120. The non-zero elevation of features 1 and 2 results in geometric magnification in the x-ray image. The difference “b1” between the location of feature 1 in the first (x-ray) image and the location of feature 1 in the second image is 1.2 mm, so the co-registration error of feature 1 is b1/a=1.2 mm/141 mm=0.009. The difference “b2” between the location of feature 2 in the first (x-ray) image and the location of feature 2 in the second image is also 1.2 mm, so the co-registration error of feature 2 is b2/a=1.2 mm/141 mm=0.009.

Generally, feature elevations of subjects are not known during use of multi-modal electronic imaging systems for animals. Without knowledge of feature elevation, it is difficult to correct for the geometric magnification in the x-ray image. However, because the co-registration error for feature 2 is reduced relative to that of known electronic imaging systems for imaging animals due to the reduced geometric magnification provided by the additional x-ray source, there is reduced ambiguity for the anatomical localization of the representation of feature 2 from the second imaging mode relative to that of known electronic imaging systems for imaging animals.

Another advantage of the present invention is that a relatively short time is required to capture an x-ray image of desirable quality from imaging systems 100, 101, 102, 107, and 108 due to the additional x-ray flux available from the additional microfocus x-ray sources.

Referring now to FIG. 8C, in operation, a plurality of subjects (such as small animals) 40 are immobilized on sample object stage 104 or 105 (step 200). An operator configures system 100, 101, 102, or 107 for imaging in a first mode, and an image of the subjects is captured in the first mode (step 202).

For imaging systems 100 and 101, for example, lens/camera system 24 captures the image of the subjects in the first mode and converts the light image into an electronic image which can be digitized.

For imaging system 102, x-ray camera 425 captures the image of the subjects in the first mode and returns an electronic image which can be digitized.

For imaging system 107, the x-ray recording medium records the image of the subjects in the first mode and is processed to return an electronic image which can be digitized.

For imaging system 108, the DR receiver panel 520 directly converts the incident radiation to digital image data.

The digitized image of the subjects imaged in the first mode is referred to as Image1 or I1. The digitized image can be displayed on the display device, stored in memory, transmitted to a remote location, processed to enhance the image, and/or used to print a permanent copy of the image. The operator then configures system 100, 101, 102, or 107 for imaging in a second mode (step 204), and an image of the subjects is captured using lens/camera system 24 in the second mode. The resulting digitized image is referred to as Image2 or I2. Both Image1 and Image2 can readily be merged or superimposed (step 206), using methods known to those skilled in the art, such that the two images are co-registered. As such, a third image can be generated comprising Image1 and Image2 and merging or combining their respective image data in some way, thereby forming a combined image.

Once imaging is complete, the objects/subjects are removed from the sample stage (step 208). The combined results of Images 1 and 2 are displayed and stored in a computer-accessible memory.

As indicated above, systems 100, 101, 102, 107, and 108 can be configured in several modes, including: x-ray imaging, bright-field imaging, dark-field imaging (including luminescence imaging, fluorescence imaging) and radioactive isotope imaging.

To configure system 100 or 101 for x-ray imaging or isotope imaging, phosphor plate 125 or 225, respectively, or other radiation image sensor type, is moved to position P1 in optical registration with sample object stage 104 (as shown in FIGS. 5B and 6) or 105. For an x-ray image, the appropriate one of the plurality of x-ray sources 103A, 103B, and 103C is employed when capturing the image of each immobilized subject. According to an embodiment of the present invention, x-ray sources 103A, 103B, and 103C are separately energized in sequence, coordinated with relative positioning of the radiation imaging receiver 110, such as phosphor plates 125, 225, x-ray camera 425, recording medium 525 or DR panel 520. In an alternate embodiment, two or more of the x-ray sources are energized at the same time.

To configure system 100 or 101 for bright-field imaging or dark-field imaging (including luminescence imaging and fluorescence imaging), phosphor plate 125 or 225, or other x-ray imaging receiver respectively, is moved to position P2, out of optical registration with sample object stage 104 (as shown in FIGS. 5C and 7) or 105, and an image of the immobilized subjects is appropriately captured.

To configure system 102 for x-ray imaging or isotope imaging, x-ray camera 425 is moved to position P1 in spatial registration with sample object stage 105. For an x-ray image, the plurality of x-ray sources 103A, 103B, and 103C is employed when capturing the image of the immobilized subjects.

To configure system 102 for bright-field imaging or dark-field imaging (including luminescence imaging and fluorescence imaging), x-ray camera 425 is moved to position P2, out of spatial registration with sample object stage 105, and an image of the immobilized subjects is appropriately captured.

To configure system 107 for x-ray imaging or isotope imaging, x-ray recording medium 525 is moved to position P1 in spatial registration with sample object stage 105. For an x-ray image, the plurality of the appropriate one of x-ray sources 103A, 103B, and 103C is employed when capturing the image of each immobilized subject.

To configure system 107 for bright-field imaging or dark-field imaging (including luminescence imaging and fluorescence imaging), x-ray recording medium 525 is moved to position P2, out of spatial registration with sample object stage 105, and an image of the immobilized subjects is appropriately captured.

To configure system 108 for bright-field imaging or dark-field imaging (including luminescence imaging and fluorescence imaging), DR panel 520 is moved to position P2, out of spatial registration with sample object stage 105, and an image of the immobilized subjects is appropriately captured.

For the purpose of optical imaging, the subjects' surfaces are defined by refractive boundaries (e.g., the skin of animals) that delineate the interior of the subjects (usually a heterogeneous, turbid media of higher index of refraction) and air. Light emanating from within subjects (e.g., luminescent or transmitted) projects to the surfaces from which it scatters, defining the light that may be productively managed to create an image of the subjects. Conversely, light may be provided from beneath optical platen 126 and scattered from the subject surfaces, thereby providing reflective light for imaging the same subjects.

For optical imaging, the definition of the subjects' boundaries may be moderated by matching the refractive index of the subjects' boundaries to support sheet 122 by introducing an index-matching fluid (e.g., water). The depth to which good focus can be achieved in optical imaging is dependent on minimizing the surface scatter of the subject being imaged. Methods such as index matching and increasing wavelength (e.g., near-infrared imaging) are well known in the art.

The emitted sample light can arise from luminescence, fluorescence or reflection, and the focal plane of the lens can be adjusted to the elevation of the subject's surfaces. Alternatively, the “light” can be ionizing radiation passing through or emitted from the subjects, or passing into the phosphor and forming an image.

Emitted gamma rays from a thick object (such as 99Tc emission from an animal organ) are distributed over the plane of the phosphor, diffusing the image by millimeters, and an appropriately thick phosphor layer (about 0.1 mm) may be preferred for increased detection efficiency. Better resolution and more precise planar projection of the emitting isotope can be achieved by gamma-ray collimation. Collimators of millimeter-resolution are available and are capable of projecting isotopic location to millimeter resolution at the plane of the phosphor in an embodiment of the present invention.

Precision registration of the multi-modal image can be accomplished using methods known to those skilled in the art.

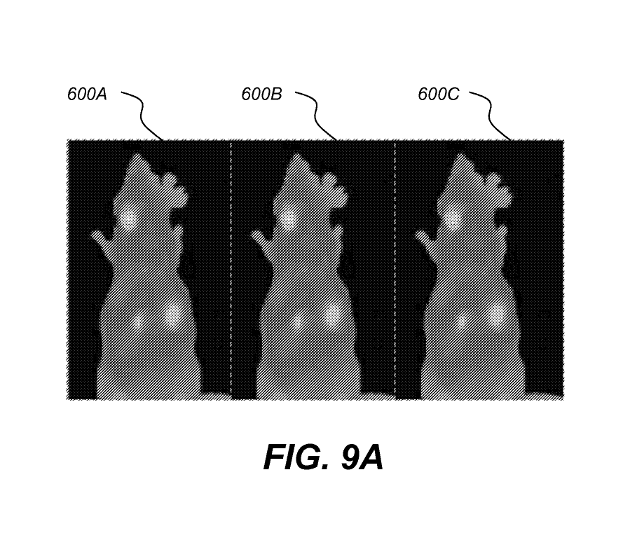

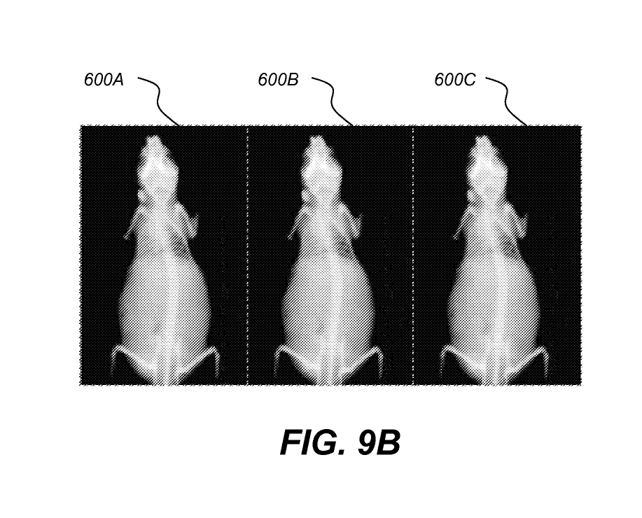

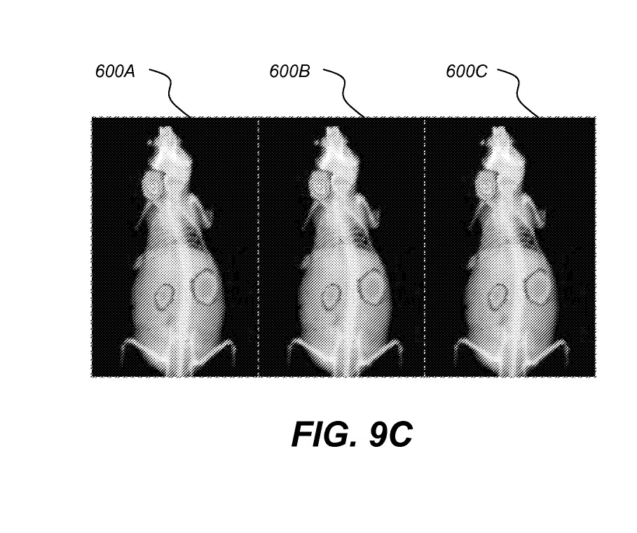

By way of example, FIGS. 9A-9C show images captured using the apparatus and method of the present invention. A plurality of subjects 40, three mice, were immobilized on sample object stage 104 (step 200 of FIG. 8C) of system 100. The mice were spatially distributed so that one mouse occupied each of three zones 600A, B, C, wherein the zones correspond to the respective coverage area of respective cone beams for the three x-ray sources 103A, 103B, and 103C. System 100 was first configured for near-infrared fluorescence imaging wherein phosphor plate 125 is removed from co-registration with frame 100.

A first image was captured and is displayed in FIG. 9A (step 202 of FIG. 8C). Next, system 100 was configured for x-ray imaging wherein phosphor plate 125 is placed in co-registration with frame 100. A second image was captured and is displayed in FIG. 9B (step 204 of FIG. 8C). Using methods known to those skilled in the art, the first and second images were merged or otherwise combined (step 206 of FIG. 8C); the merged image is displayed in FIG. 9C. Note that the fluorescent signals superimposed on the anatomical reference clarify the assignment of signals to the bladders and expected tumors in the neck area of this illustrated plurality of experimental mice.

It is noted that the first and/or second image can be enhanced using known image processing methods/means prior to being merged. Alternatively, the merged image can be enhanced using known image processing methods/means. Often, false color is used to distinguish fluorescent signal from gray-scale x-rays in a merged image.

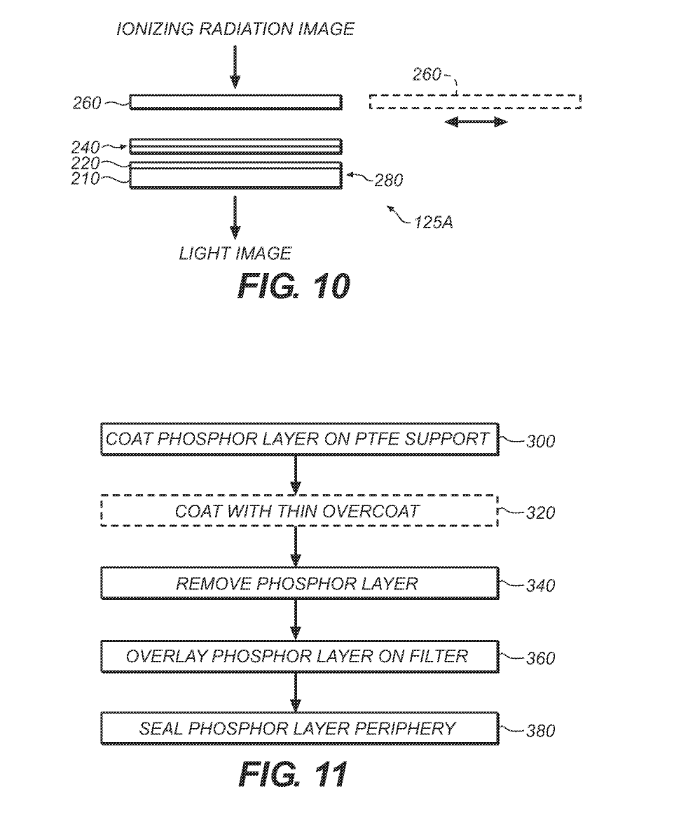

A phosphor plate suitable for use with the apparatus and method of the present invention is disclosed in U.S. Pat. No. 6,444,988 (Vizard), commonly assigned and incorporated herein by reference. A phosphor plate as described in Vizard is shown in FIG. 10. A suitable phosphor plate 125A for use with the apparatus and method of the present invention includes a transparent support 210 (such as glass) upon which is coated an interference filter 220 which is a multicoated short-pass filter designed to transmit light at a specified wavelength (and below) and reflect light above that wavelength. Plate 125A also includes a thin phosphor layer 240 and a removable thick phosphor layer 260. Thin phosphor layer 240 is used for high resolution imaging applications of ionizing radiation or for very low energy (self-attenuating) ionizing radiation such as low-energy electrons or beta particles. Thick phosphor layer 260 is used for high energy ionizing radiation that freely penetrates the phosphor. Thick phosphor layer 260 is removable and is shown in FIG. 4B overlaying thin phosphor layer 240. Layer 260 is removable to the position shown in dashed lines out of contact with layer 240.

The phosphor preferably used in phosphor layers 240 and 260 is Gadolinium Oxysulfide: Terbium whose strong monochromatic line output (544-548 nanometers (NM) is ideal for co-application with interference optics. This phosphor has technical superiority regarding linear dynamic range of output, sufficiently “live” or prompt emission and time reciprocity, and intrascenic dynamic range which exceed other phosphors and capture media. This phosphor layer preferably has a nominal thickness of 10-30 micrometers (μm) at 5-20 grams/square foot (g/ft2) of phosphor coverage, optimally absorbing 10-30 Key x-rays. Thick phosphor layer 260 has a nominal thickness of 100 μm at 80 g/ft2 of phosphor coverage.

The duplex phosphor layers impart flexibility of usage for which the thick phosphor layer 260 may be removed to enhance the spatial resolution of the image. Thin phosphor layer 240 intimately contacts filter 220, whereas thick phosphor layer 260 may be alternatively placed on thin phosphor layer 240.

Interference filter 220 transmits light at 551 NM and below and reflects light above that wavelength. Filter 220 comprises layers of Zinc Sulfide-Cryolite that exhibits a large reduction in cutoff wavelength with increasing angle of incidence. The filter has a high transmission at 540-551 NM to assure good transmission of 540-548 NM transmission of the GOS phosphor. The filter also has a sharp short-pass cut-off at about 553 NM, that blue shifts at about 0.6 NM per angular degree of incidence to optimize optical gain.

Glass support 210 should be reasonably flat, clear, and free of noticeable defects. The thickness of support 210 can be 2 millimeters. The opposite side 280 of glass support 210 is coated with an anti-reflective layer (such as Magnesium Fluoride, green optimized) to increase transmittance and reduce optical artifacts to ensure that the large dynamic range of the phosphor emittance is captured.

FIG. 11 shows steps of a method of producing phosphor layer 240. In step 300, a mixture of GOS:Tb in a binder is coated on a polytetrafluoroethylene (PTFE) support. The PTFE support enables release of the coated phosphor layer from the PTFE support and subsequent use of the phosphor layer without support, since conventional supporting materials are an optical burden to phosphor performance. For the thin phosphor layer 240, at step 320 an ultra thin (about 0.5 g/ft2, 0.5 μm thick) layer of cellulose acetate overcoat can be applied to offer improved handling characteristics of the thin phosphor layer and to provide greater environmental protection to the underlying optical filter. At step 340, the phosphor layer is removed from the PFTE support. At step 360, the thin phosphor layer overcoated side is overlayed on interference filter 220. Clean assembly of the thin phosphor layer 240 and filter 220 assures an optical boundary that optimizes management of phosphor light output into the camera of the lens/camera system. Optical coupling of layer 240 and filter 220 is not necessary, since performance reduction may result. At step 380, layer 240 can be sealed around its periphery and around the periphery of filter 220 for mechanical stability and further protection of the critical optical boundary against environmental (e.g., moisture) intrusion.

Advantages of the present apparatus include: provides anatomical localization of molecular imaging agent signals in small animals, organs, and tissues; provides precise co-registration of anatomical x-ray images with optical molecular and radio isotopic images using one system; promotes improved understanding of imaging agent's biodistribution through combined use of time lapse molecular imaging with x-ray imaging; and allows simple switching between multi-wavelength fluorescence, luminescence, radio-isotopic, and x-ray imaging modalities without moving the object/sample.

Optional transport apparatus 60 for translating, rotating, or otherwise moving the imaging receiver between positions within and outside the x-ray imaging path can have any of a number of different forms and may be fully automated, partially automated, or manually actuated. According to one embodiment of the present invention, transport apparatus 60 consists simply of slides for manually translating the phosphor plate or other type of imaging receiver to the proper position for the type of image being obtained. In an alternate embodiment, a motor or other actuator is provided for adjusting the translational or rotational position of the imaging receiver appropriately.

The invention has been described in detail with particular reference to a presently preferred embodiment, but it will be understood that variations and modifications can be effected within the spirit and scope of the invention. For example, an imaging system can have two, three, four, or more ionizing radiation sources and may have various types of illumination sources. The presently disclosed embodiments are therefore considered in all respects to be illustrative and not restrictive. The scope of the invention is indicated by the appended claims, and all changes that come within the meaning and range of equivalents thereof are intended to be embraced therein.

What is claimed is:

1. An imaging system for imaging at least a first and a second subject, comprising:
a support stage adapted to support the at least first and second subjects;
an imaging system comprising:
(a) an ionizing radiation imaging section including:
(i) at least a first ionizing radiation source energizable for directing ionizing radiation toward the support stage and within a first zone that includes at least a portion of the first subject and a second ionizing radiation source energizable for directing ionizing radiation within a second zone that lies substantially outside the first zone and that includes at least a portion of the second subject; and
(ii) at least one imaging receiver that forms a radiation image of the subject within each zone according to incident ionizing radiation; and
(b) a camera system energizable to obtain at least one illumination image of the at least first and second subjects; and
a computer in signal communication with the imaging system and energizable to form a combined image from the radiation image and the illumination image of the same subjects obtained from the imaging system.

2. The imaging apparatus of claim 1 wherein the ionizing radiation imaging section further comprises a transport apparatus that is actuable to move the at least one imaging receiver between at least a first imaging position and a second position.

3. The imaging system of claim 1 further comprising a display in signal communication with the computer and energizable to display the combined image.

4. The imaging system of claim 1 wherein the first and second ionizing radiation sources are microfocus x-ray emitters.

5. The imaging system of claim 1 wherein the at least one imaging receiver is an x-ray camera.

6. The imaging system of claim 1 wherein the at least one imaging receiver is a digital receiver panel.

7. The imaging system of claim 1 wherein the at least one imaging receiver comprises a phosphor plate.

8. The imaging system of claim 7 wherein the camera system is further energizable to obtain an image of the imaging receiver.

9. The imaging system of claim 1 wherein the imaging system further comprises a light imaging section that comprises one or more illumination sources energizable to direct illumination toward the at least first and second subjects on the support stage.

10. The imaging system of claim 9 wherein at least one of the one or more illumination source comprises optical fibers.

11. An imaging system for imaging at least first and second immobilized subjects, the system comprising:
a support stage adapted to receive the at least first and second subjects in an immobilized state;
a camera disposed to obtain at least a first image of the at least first and second subjects in a first imaging mode that employs light from the immobilized subjects; and
an ionizing radiation imaging section for obtaining a second image of the at least first and second subjects in a second imaging mode, wherein the ionizing radiation imaging section comprises at least:
(i) a first ionizing radiation source energizable for directing ionizing radiation within a first zone that includes at least a portion of the first subject;
(ii) a second ionizing radiation source energizable for directing ionizing radiation within a second zone that includes at least a portion of the second subject and that lies substantially outside the first zone; and
(iii) a movable phosphor plate that transduces ionizing radiation to visible light, wherein the phosphor plate includes a phosphor plane and wherein the phosphor plate is mounted to be moved, while the subjects remain immobilized on the support stage, between a second position proximate the support stage for capture of the second image and a first position further away from the support stage for capture of the first image.

12. The imaging system of claim 11 wherein the first and second ionizing radiation sources are microfocus x-ray emitters.

13. The imaging system of claim 11 wherein the imaging system further comprises one or more illumination sources for providing illumination to the first and second subjects.

14. An imaging system for imaging at least first and second immobilized subjects, the system comprising:
a support stage adapted to receive the at least first and second subjects in an immobilized state;
a camera disposed to obtain at least a first image of the at least first and second subjects in a first imaging mode that uses light from the immobilized subjects; and
an ionizing radiation imaging section for obtaining a second image of the at least first and second subjects in a second imaging mode, wherein the ionizing radiation imaging section comprises at least:
(i) a first ionizing radiation source energizable for directing ionizing radiation toward the support stage and within a first zone that includes at least a portion of the first subject;
(ii) a second ionizing radiation source energizable for directing ionizing radiation within a second zone that lies substantially outside the first zone and that includes at least a portion of the second subject;
(iii) a movable x-ray camera that is mounted to be moved, while the subjects remain immobilized on the support stage, between a first position for and during capture of the first image and a second position, closer to the support stage, for and during capture of the second image.

15. The imaging system of claim 14 wherein the imaging system further comprises one or more illumination sources for providing illumination to the first and second subjects.

16. A method for forming a multimodal image for at least a first subject and a second subject, comprising:
supporting the at least first and second subjects on a support stage;
directing ionizing radiation within a first zone that includes at least a portion of the first subject;
directing ionizing radiation within a second zone that lies substantially outside the first zone and includes at least a portion of the second subject;
acquiring a radiation image of the first and second subjects;
directing illumination toward the at least first and second subjects on the support element and acquiring an illumination image of the at least first and second subjects; and
forming a combined, multimodal image of the subjects from the radiation image and the illumination image.

17. The method of claim 16 further comprising indexing a radiation receiver to a first position for acquiring the radiation image for the first subject and to a second position for acquiring the radiation image for the second subject.

18. The method of claim 16 wherein at least one of the first and second subjects is a mammal.

19. An imaging system for imaging at least a first and a second subject, the system comprising:
a support stage adapted to support the at least first and second subjects;
an imaging system comprising:
(a) an ionizing radiation imaging section that comprises:
(i) at least a first ionizing radiation source energizable for directing ionizing radiation toward the support stage and within a first zone that includes at least a portion of the first subject and a second ionizing radiation source energizable for directing ionizing radiation within a second zone that lies substantially outside the first zone and that includes at least a portion of the second subject;
(ii) at least one imaging receiver that forms an image of the subject within each zone according to incident ionizing radiation; and
(iii) a light imaging section that comprises one or more illumination sources energizable to direct illumination toward the at least first and second subjects on the support stage; and
(b) a camera system energizable to obtain at least one image of the at least first and second subjects; and
a computer in signal communication with the imaging system and energizable to form a combined image from two or more images of the same subjects obtained from the imaging system.
